(19) United States
(12) Patent Application Publication
(10) Pub. No.: US 2012/0256021 A1
(43) Pub. Date: Oct. 11, 2012

(54) PARTICLE DISTRIBUTOR FOR AGRICULTURAL MATERIALS

(76) Inventor: John D. DeLorme, Spencerport, NY (US)

(21) Appl. No.: 13/440,091

(22) Filed: Apr. 5, 2012

Related U.S. Application Data
(60) Provisional application No. 61/516,691, filed on Apr. 6, 2011.

(51) Int. Cl. A01C 17/00

(52) U.S. Cl. 239/686

(57) ABSTRACT

A portable distributor for particles, especially of grass seed and fertilizer, has a platform connected to a strap which goes over the shoulder of the individual carrying the distributor. The platform has a turn crank for rotating a set of gears connected to a shaft that rotates a circular finned spreader. The spreader is located over a slot in the platform through which the particles fall and are distributed in a circular pattern. The gears and other movable parts of the distributor are contained within a cover between the platform and spreader so that it caps the gears and a portion of a plate that adjusts the width of the slot. The cover prevents the gears to be clogged by the particles being distributed and also enhances safety by preventing the individual operating the crank and carrying the distributor from engaging the gearing with his or her hands or clothing.

Priority is claimed from U.S. Provisional Patent Application Ser. No. 61/516,691, filed Apr. 6, 2011, which is herein incorporated by reference.

The present invention relates to distributors for particles, especially particles of agricultural material, such as seed and fertilizer. The invention is especially suitable for use in a portable, hand-held distributor which is carried by an operator.

It is a feature of the invention to make the distributor more reliable by preventing clogging thereof by the particles as they are distributed and for enhancing the safety of the operator by preventing engagement of the operator's hands or clothing with the moving parts of the distributor.

Hand-held and portable distributors for seed and fertilizer have been used in preparing feed plots for feeding wild animals, such as deer. Such plots may be in inhospitable areas and require fertilization and seeding in order to grow grass which attracts the animals and on which the animals feed. Heretofore, portable distributors have used hand-crank gearing and movable panels for metering the particles onto a spreader rotated by the hearing. The spreader has fins thereon which throw the particles outward for spreading. It has been found that the particles can clog the gearing and interfere with mechanism controlling the width opening of a discharge slot for the particles provided by a movable metering panel. Also, the crank may be turned by the operator when the operators hand is close to the gearing and the gearing may cause injury to the fingers of the operator's hand and may also injure the operator by snagging the operator's clothing.

It is the principle feature of this invention to enhance the reliable operation of the distributor and safety of the operator by enclosing the gearing and other movable parts of distributor with a cover disposed between a platform on which the gearing and metering panel cover are mounted and the rotating spreader against which the particles fall when the gearing is turned as by a hand crank.

It is also a feature of the invention to provide a cover which conforms with the movable parts of the spreader and prevents contact thereof with the particles as they are being distributed and also prevents engagement of the movable parts with clothing or the fingers of the hand of the operator.

It is a feature of the invention to provide these advantages as set forth above by locating the cover between a platform on which the gearing and a cover of a panel which meters the particles are movably mounted and the rotatable spreader which distributes the falling particle.

The foregoing and other objects and features of the invention will become more apparent from a reading of the following description in connection with the accompanying drawings in which:

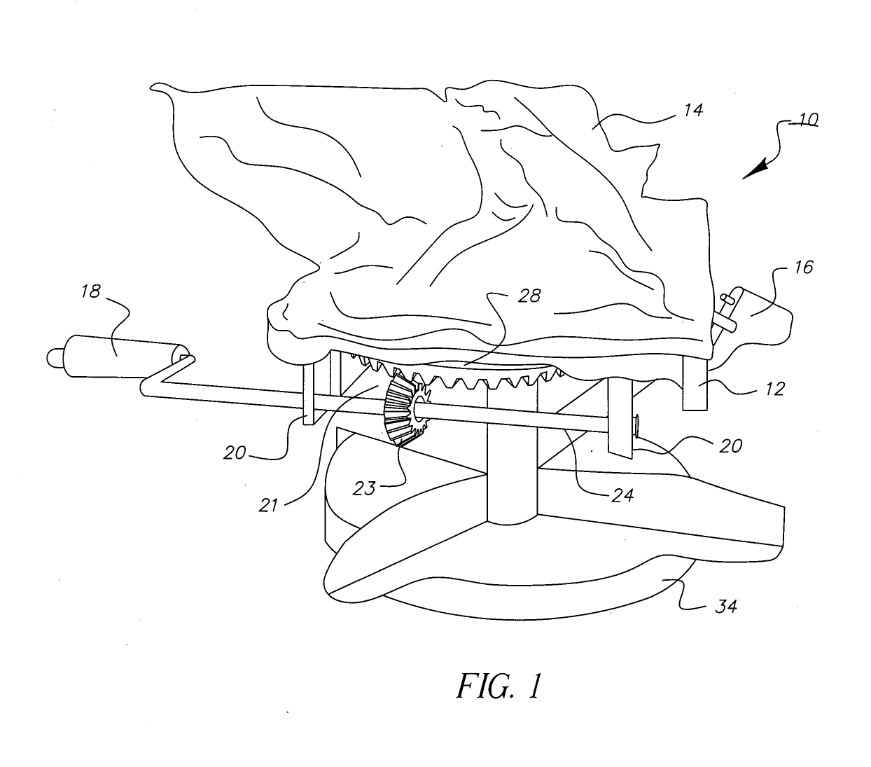

FIG. 1 is a perspective view of a portable particle distributor which can be carried by the operator but in which the cover afforded by the invention is not shown;

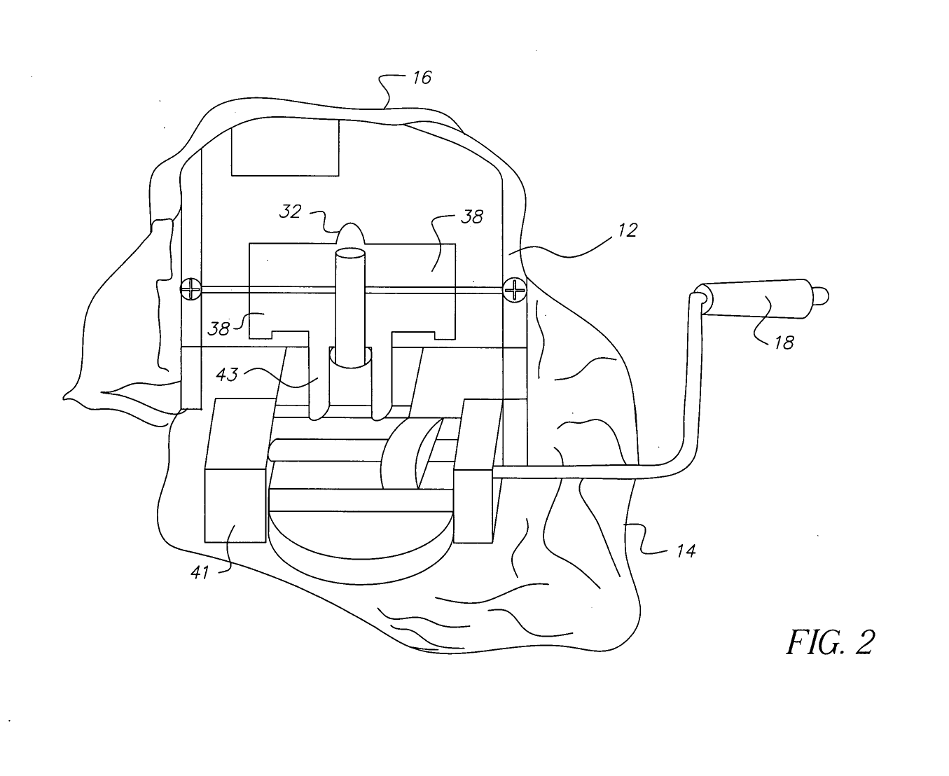

FIG. 2 is a bottom view of the distributor showing the shaft which is rotated by the hand crank via gearing, and the movable metering panel, but where the cylinder carrying the fins of the rotatable spreader has been removed;

FIG. 2A is an enlarged perspective view from the side showing the rotating finned spreader, the platform, and the cover, and illustrating how the cover is disposed between the rotating spreader and the platform which supports the gearing and the metering panel of the distributor;

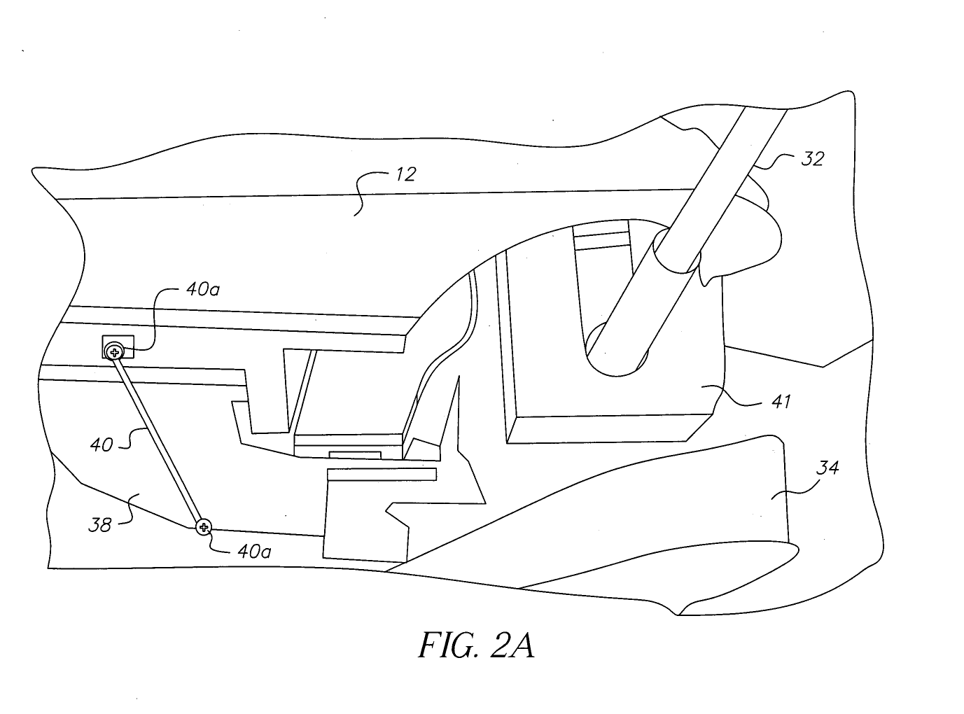

FIG. 3 is a bottom view of the distributor with the rotating cylindrical spreader removed, showing the cover and the metering panel mounted on the platform and also illustrating the bag on top of the platform into which the particles to be distributed are contained;

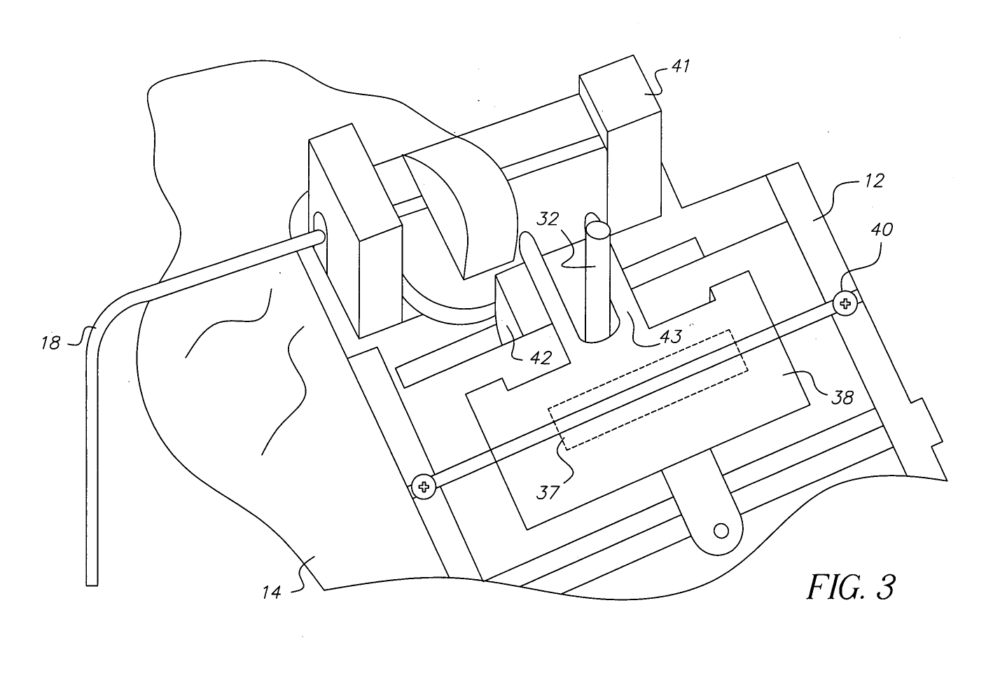

FIG. 4 is a perspective view of the cover taken from the rear thereof;

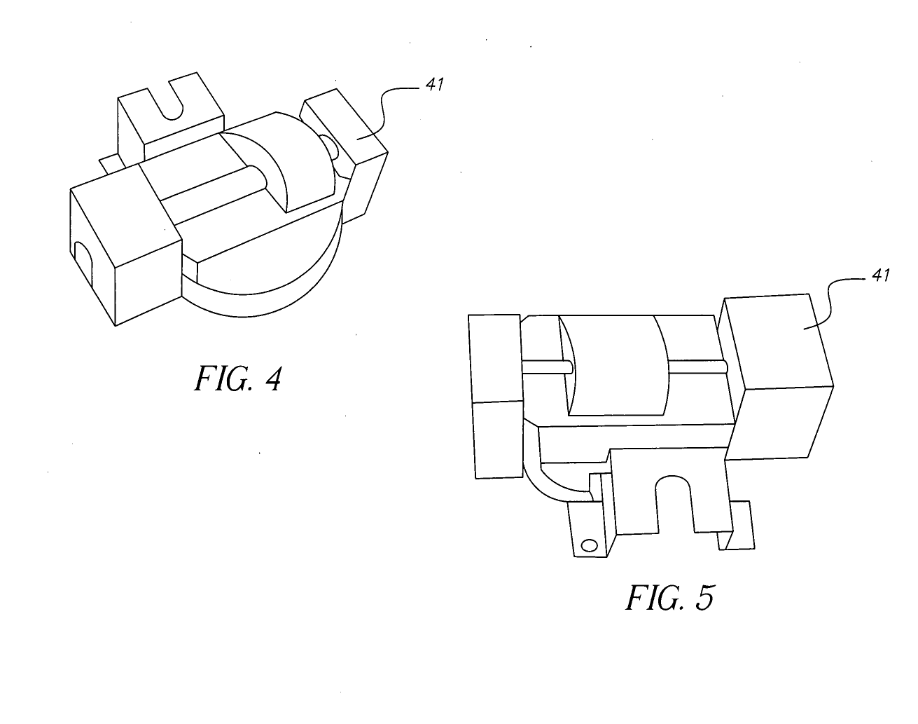

FIG. 5 is a perspective view of the cover taken from the front thereof;

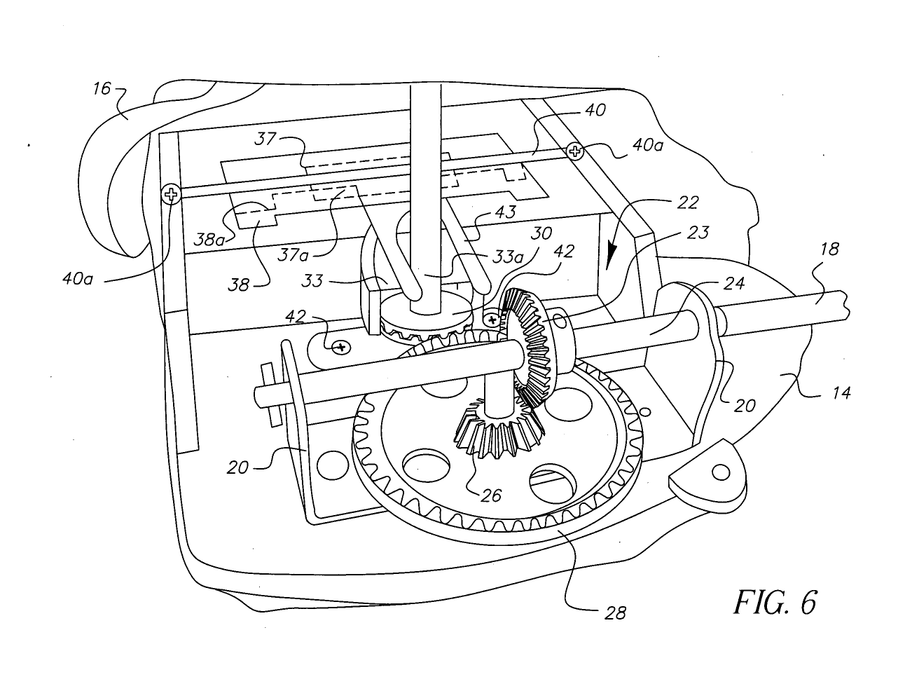

FIG. 6 is a perspective and schematic view of the bottom of the distributor showing the gearing and the output shaft from the gearing mounted on the platform but without the crank and the distributing fin cylinder;

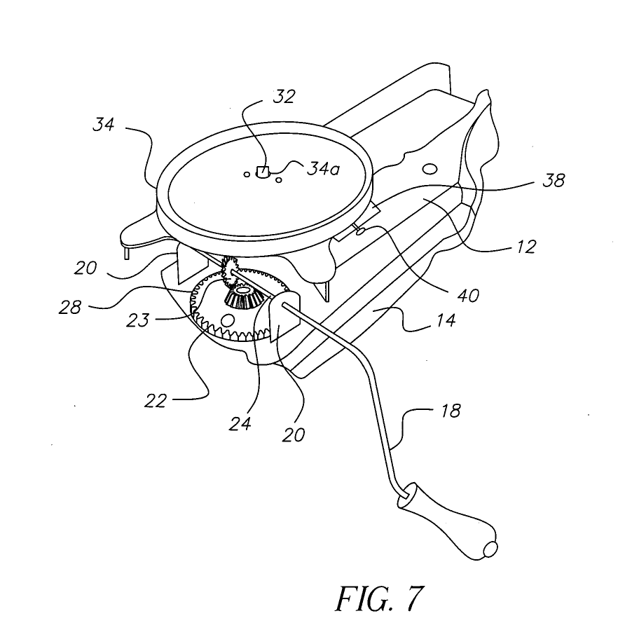

FIG. 7 is a perspective view similar to FIG. 6 showing the rotating spreader connected to and rotated by the hand cranked gearing and also showing other movable parts of the distributor;

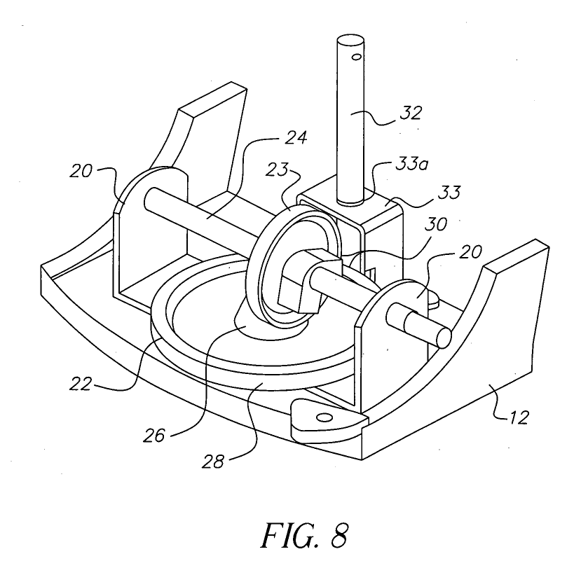

FIG. 8 is a schematic view of the gearing and the output shaft thereof; and

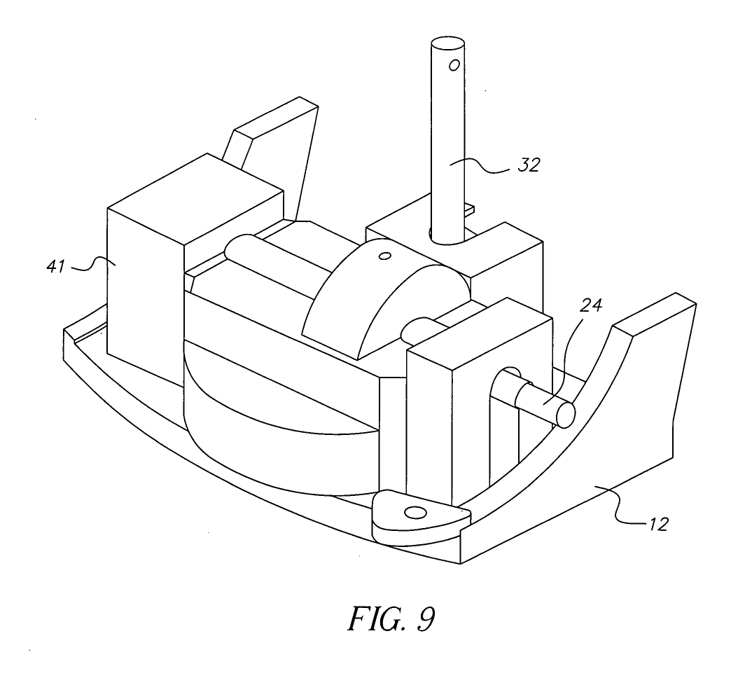

FIG. 9 is a perspective view of the cover mounted on the platform and enclosing the gearing 42

Referring more particularly to the drawings, there is shown a hand-operated and portable distributor 10. A platform 12 carried, on the top thereof, a bag 14 in which the seeds, fertilizer, or other particles may be contained. The portable distributor 10 may be carried on the shoulder or around the neck of the operator by means of a long strap 16.

A hand-operated crank 18 has a shaft supported in pillow blocks 20 on the platform 12. Gearing 22 is mounted on the platform 12 including a drive gear 23 on the crank shaft 24, a bevel gear 26 on a main gear 28, and another spur gear 30, on an output shaft 32 from the gearing. Output shaft 32 extends downwardly and is connected by insertion into a bore 34a of a spindle on the rotatable, cylindrical, finned spreader 34, shown also in FIG. 1. The spreader 34 extends rearwardly along the platform 12 over a discharge slot or opening 37 in the platform. Slot 37 is shown in dashed lines in FIGS. 3 and 6. Blocking of slot 37 is controlled by the position of a movable metering panel 38. FIGS. 2, 3, and 6 show meter panel 32 at its most forward position fully blocking slot 37. Panel 32 is movable backwards away from shaft 32 towards the rear of platform 12, such as shown, for example, in FIG. 6 illustrating the forward edge of panel 38 moved backwards, as indicated by dashed line 38a, to an extent enable particles particle flow at 37a of opening 37. This thereby selects the width (or size of slot 37) through which the particles (seed and fertilizer) from the bag 14 can drop (by gravity) onto the inside face of hand cranked rotatable, finned spreader 34, and thereby meters the volume of flow of particles from distributor 10. The panel 38 is retained on the platform 12 by a wire strap 40 so that panel 38 can be moved towards the rear of the platform 12 (or away there from) by an operator when desired in order to select the width (or size) of slot 37 and desired metered volume of particle flow. Wire strap is attached to platform 12 by screws 40a. The spreader 34 is disposed below this metered slot or opening 37 of selected width so that the dropping particles drop on the inside face of the spreader 34 and are engaged by the fins thereon so as to be thrown outwardly and spread around the distributor 10.

The dropping particles can often enter between the teeth of the gearing 22 and clog the gears. They also can interfere and prevent changing of the position of the metering panel 38 when it is desired to change the volume of particles to be distributed by opening or closing slot 37 in platform 12 thereby changing the width of this slot. To this end, and also to prevent clothing of the operator from entering between the teeth of the gearing 22, a cover or cap 41 is located between the platform 12 and the cylindrical spreader 34. This cover 41 is a shell of generally rectangular configuration is attached to the platform 12 as by screws 42 which may also attach a bracket 33 having an opening 33a to guide the output shaft 32. These screws 42 are shown in FIG. 6. The cover 41, as shown in FIGS. 2, 6, 7, 8, and 9 conforms to the gearing (or gears) 22 and 23, two pillow blocks 20 which mount the crank shaft 24, bracket 33, and crank shaft 24 between pillow blocks 20. The cover 41 also extends over the output shaft 32 under two prongs of a guidance tongue 43 of the movable metering panel 38.

Inasmuch as the cover 41 conforms to the shape of the gears 22 and 23, and shaft 24 and the metering panel tongue 43, the cover 41 caps and encloses all of the moving parts of the distributor 10 which can be exposed to the falling particles, and is located between the rotating finned spreader 34 and the platform 12, the probability of clogging of the gearing and of the movement of the metering panel 38 is minimized. Also, tangling of the operator's clothing in the gearing 22 or in the tongue 43 extending from the metering panel 38 is avoided.

From the foregoing description, there has been provided an improved portable distributor which is provided with operating and safety functions by virtue of the use and strategic placement of a cover or cap on the platform on which all of the parts of the spreader are mounted. Even the rotating spreader 34 is mounted on the platform by being connected to the output shaft 32 from the crank gearing 22.

Variations and modifications in the herein described spreader will undoubtedly suggest themselves to those skilled in the art. Accordingly, the foregoing description should be taken as illustrative and not in a limiting sense.

1. A portable and manually operated distributor of agricultural, particulate material which comprises:
a platform having an opening;
a bag containing the material on one side of said platform;
a movable panel on the opposite side of said platform for metering the material passing through said opening;
a gearing mounted on the opposite side of said platform, and a hand crank coupled to said gearing in which movement of said hand crank is translatable to move said gearing;
a cylindrically shaped spreader coupled to said gearing for rotating said spreader for spreading the material received via said opening metered by said movable panel; and
a cover disposed between said platform and said spreader and conforming in shape to said gearing and parts of said panel exposed to the dropping of material from said bag, said cover preventing the material dropping from said bag through said platform outside of said opening, and being operative to divert the dropping particulate material from said gearing and protecting said gearing from engaging a hand, other appendages and clothing of an operator of said distributor when manipulating said hand crank and said movable panel.

2. The distributor of claim 1 wherein said gearing is on an upper side of the platform which is said one side of said platform, and said distributor further comprising a shaft through said platform connected to said gearing and said spreader for rotating said spreader when said hand crank is turned.

3. The distributor of claim 2 wherein said cover has a slot via which said shaft passes to said spreader.

4. The distributor of claim 1 wherein said cover is a shell.

5. The distributor of claim 4 wherein said shell encloses on said platform said gearing and the parts exposed to falling material.

6. The distributor of claim 1 further comprising a strap connected to said platform which is worn by the operator when operating said distributor.

7. The distributor of claim 1 wherein said cylindrically shaped spreader is a wheel having fins extending radially from the center thereof and outwardly over said metered opening in the platform through which the particles fall and are distributed in a circular pattern around and away from said platform.

8. The distributor of claim 1 wherein said movable panel meters the material passing through said opening by adjusting the size of the opening.

9. A portable, manually operated distributor of particles comprising seeds and fertilizer which fall upon a spreader, said distributor comprising:
means for manually rotating the spreader to enable spreading of the particles which fall through a platform from the underside thereof and on the upper side of which a container of said particles is disposed; and
means on the underside of the platform for containing rotatable and movable parts on which the particles can fall.

10. The distributor of claim 9 wherein said containing means is a cover enclosing said parts.

11. The distributor of claim 9 wherein said cover is a shell conforming to the shape of said parts, said shell being located on the underside of said platform and having a slot for a shaft which rotates said spreader.

12. The distributor of claim 9 wherein said shell has portions which receive fasteners attaching said shell to the underside of said platform.

13. A system for distributing particles which fall upon a rotating spreader comprising:
gearing which is coupled to the spreader to rotate the spreader to enable spreading of the particles when falling on said spreader; and
a cover over of at least said gearing to protect an operator from said gearing.

14. The system of claim 13 further comprising means for manually moving said gearing by said operator.

15. The system of claim 13 wherein said cover conforms to the shape of at least said gearing.
